(19) United States
(12) Patent Application Publication
(10) Pub. No.: US 2012/0118296 A1
(43) Pub. Date: May 17, 2012

(54) EROTIC APPARATUS AND HARNESS DEVICE

(76) Inventor: JUSTIN OELTJEN, TALLAHASSEE, FL (US)

(21) Appl. No.: 12/946,245

(22) Filed: Nov. 15, 2010

(51) Int. Cl. A61G 99/00

(52) U.S. Cl. 128/845

(57) ABSTRACT

The claimed erotic apparatus (also known as Bangerbars, Bang-her-bars, and Motosexbars) can consist of a sex toy apparel item (e.g., a harness) that attaches grip devices to a person or persons. In one embodiment, the grips are to resemble (in look and feel) handlebars of a motorcycle or other such vehicle. In this manner the erotic apparatus can be utilized to simulate the thrill one attains from riding a handlebar operated vehicle while at the same time allowing for sexual stimulation and intercourse. Grip components can be interchangeably attached to the harness sex toy device in an embodiment in accordance of the disclosure. Moreover, optional components, such as vibrators, dildos, cock rings, and the like, can be coupled to the erotic apparatus in accordance with an embodiment of the disclosure.

### BACKGROUND

The field of the disclosure relates to sexual aid devices, and more particularly, an erotic apparatus that combines of the thrill of sexual satisfaction and the thrill of using a handlebar operated mode of transport.

Individuals continually engage in various forms of entertainment. One such choice for an entertainment activity is operating handlebar manipulated forms of transport, for example, motorcycles, ATVs, or JETSKIs. They provide riders with a sense of thrill and adventure. In fact, there exist countless clubs and organizations dedicated to sharing the experience for such handlebar operated entertainment, for example Harley Davidson Rider Clubs or larger scale events such as Daytona's Bike Week.

Another area of thrill is in attaining sexual satisfaction. Individuals often select sex aid devices to enhance sexual satisfaction; items such as vibrators, dildos, cock rings and the like, or clothing ensembles that can enhance imaginative sexual play, either individually or between partners, such as role play and fetishes. Harnesses are often used to constrain and at times manipulate movement of a partner's limbs.

### SUMMARY

In accordance with an embodiment of the disclosure, the claimed erotic apparatus, also known as Bangerbars, Bang-her-bars, and Motosexbars, can consist of a sex toy apparel item that attaches grip devices to a person or persons. In one embodiment, the grips are to resemble (in look and feel) handlebars of a motorcycle or other such vehicle and can be side grips positioned about the hips of an individual when worn.

More specifically, with the erotic apparatus, one or more grip devices (e.g., handles) can be attached to a person or persons with one or more belts or straps. The belts or straps can hold the one or more handles and any potential expansionary devices for the erotic apparatus in place against the person's body, (e.g., at a person's hips, thighs, stomach, buttocks, shoulders, chest, head, and the like). In one embodiment, controls (e.g., a clutch, throttle, brake, starter, light switch, or turn signals) may be added and can simulate, for example, gear change devices for a mode of transportation. This can include an ability to engage various options typical of a motorcycle depending on options included within the erotic apparatus device (e.g., horn, turn signals, throttle, rumbling noises/vibrations experienced when on a motorcycle, which are simulated by components integrated into or controlled by the erotic apparatus.)

In another embodiment, these added controls can manipulate stages of other sexually stimulating devices (e.g., vibrators, cock rings, and nipple clamps, anal beads, handcuffs, etc.) that can be added to the sex toy apparel item. In yet another embodiment, a set of modular attachments can be selectively added to the main erotic apparatus, or harness device, which represents a post-sale stream of income for improvements to the base model, in accordance with the disclosure.

Thus, the erotic apparatus combines the pleasure of sex with the pleasure of operating a handlebar manipulated form of transport, for example a motorcycle, ATV, or JET SKI. In other words, a person having sex aided by this device can effectively be “riding a motorcycle” during intercourse. One targeted market for this artifact is at motorcycle events (e.g., Daytona's Bike Week, etc.), during which abnormally high sales are projected via sales to lust filled, less than sober, motorcycle obsessed individuals.

### BRIEF DESCRIPTION OF THE SEVERAL VIEWS OF THE DRAWINGS

FIG. 1 is a schematic diagram and depiction of embodiments of an erotic apparatus harness device with components that allow an individual to experience the sensation of operating a handlebar manipulated form of transport while engaging in intercourse or sexual stimulation in accordance with an embodiment of the disclosure.

FIG. 2 is a depiction that shows additional details specific to the grip component types in accordance with an embodiment of the disclosure.

FIG. 3 is a set of depictions of potential examples for a coupling device that can be used to fasten the one or more grip components to the harness in accordance with an embodiment of the disclosure.

FIG. 4 is a depiction of examples for strap tightening and fastening mechanisms in accordance with an embodiment of the disclosure.

FIG. 5 is a depiction of an example of a legacy adapter that allows legacy sex toy devices to be functionally incorporated into the claimed erotic apparatus in accordance with an embodiment of the disclosure.

### DETAILED DESCRIPTION

A harness combining the thrill of operating a handlebar manipulated form of transport and the thrill of attaining sexual satisfaction can consist of a set of modular straps forming a support harness that can have attached components for emulating the use of a handlebar operated mode of transport. As used herein, a harness can function as a looped restraint or support item. The item can be worn by both men and women. However, modifications may be needed depending on which sex wears the item so as to ensure that the wearer's genitals and/or orifices are exposed for sexual stimulation, for example oral sex, and/or intercourse, be it straight, gay, anal, etc. One or more grip devices or handlebars can be attached to the wearer's body via the harness to allow a wearer's partner to experience the pleasure of operating, for example, a motorcycle while simultaneously engaging in sexually pleasurable and satisfying acts. The one or more grip devices can be attached to, for example, the wearer's hips, thighs, stomach, buttocks, shoulders, chest, head, and the like.

As used herein, grips and handlebars can be cylindrically shaped in form and usually refer to the steering mechanism for bicycles, motorcycles, ATVs, snowmobiles and personal watercraft; the equivalent of a steering wheel. Besides acting as a steering mechanism, handlebars may also support a portion of the rider's weight, steadying him or her depending on the riding position. The riding position can in this instance by extension refer to a sexual position, for example missionary, doggy-style, cowgirl, and the like. Moreover, handlebars often provide a mounting place for controls such as brake, throttle, clutch, horn, light switch, and rear view mirrors; that is the handlebars can function as support for extension devices.

The present disclosure is described with reference to the attached figures, wherein similar reference numerals are used throughout the figures to designate similar or equivalent elements. The figures are not drawn to scale and they are provided merely to illustrate the instant disclosure. Several aspects of the disclosure are described below with reference to example applications for illustration. It should be understood that numerous specific details, relationships, and methods are set forth to provide a full understanding of the disclosure. One having ordinary skill in the relevant art, however, will readily recognize that the disclosure can be practiced without one or more specific details or with other methods. In other instances, well-known structures or operations are not shown in detail to avoid obscuring the disclosure. The present disclosure is not limited by the illustrated ordering of acts or events, as some acts can occur in different orders and/or concurrently with other acts or events. Furthermore, not illustrated acts or events are required to implement a methodology in accordance with the present disclosure.

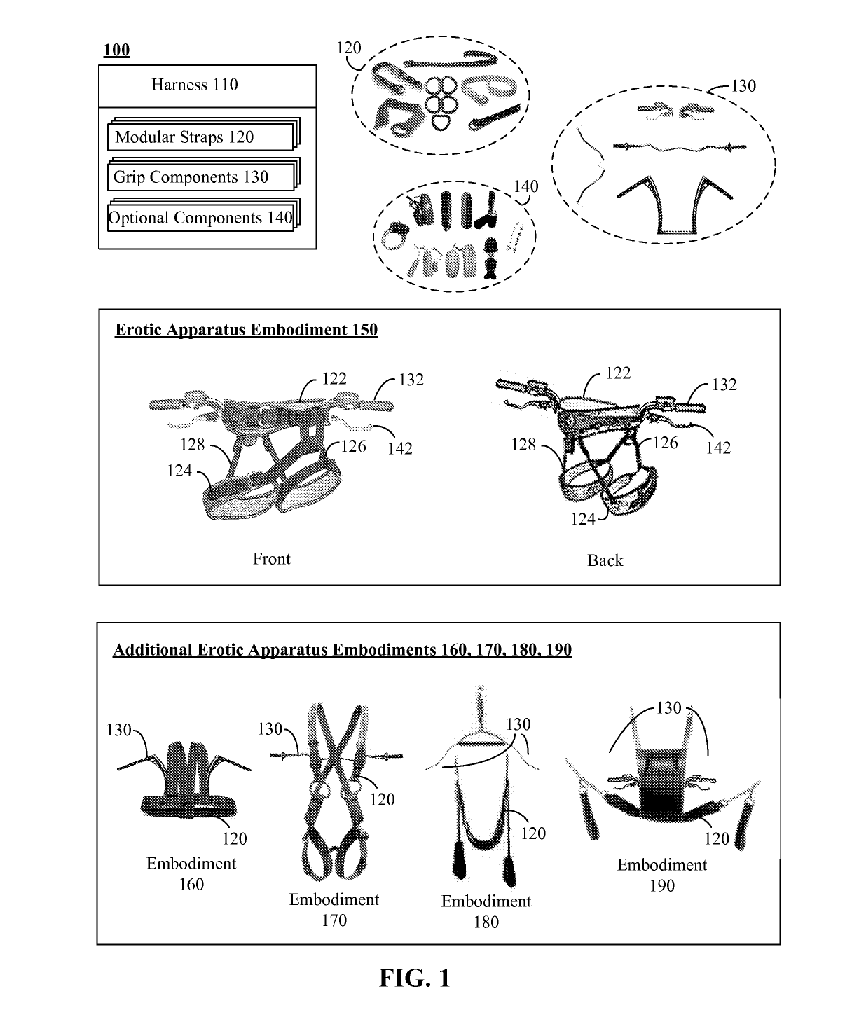

FIG. 1 is a schematic diagram 100 and depiction of embodiments 150, 160, 170, 180, 190 of an erotic apparatus harness 110 device with components 130, 140 that allow an individual to experience the sensation of operating a handlebar manipulated form of transport while engaging in intercourse or sexual stimulation in accordance with an embodiment of the disclosure. Harness 110 can include modular straps 120 and one or more grip components 130. Harness 110 can also include zero or more optional components 140. Modular straps 120 can be varying in size and nature throughout the harness 110 in accordance with strap 120 position, purpose, and user preference. For instance, a thicker width and cushioned strap may be worn by a person across his or her hips or shoulders as well as around his or her thighs, while support straps 120, which can connect the hip, shoulder and thigh straps, can be non-cushioned and of a thinner width than support straps 120 worn about a person's hips. In contrast, for users whose sexual preferences tend towards rougher fetishes such as S&M, support straps 120 may also be fashioned from more abrasive material and include spikes regardless of whether the straps 120 are worn about a user's hips, shoulders, or function as thigh straps or connector straps. Furthermore, the modular straps 120 may also include hardware to facilitate fastening the erotic apparatus to objects, such as bedposts, walls, shower rods, tantra chairs, and the like.

Materials that are well suited for the purposes of combining straps 120 to form a harness 110 can be leather, felt, thick cloth, cushioned PVC, rope, and the like. Straps 120 may or may not be stretchable and can be adjusted and secured to fit an individual person through various techniques, including but not limited to VELCRO, buttons, belt buckles, and the like. Straps 120 can be placed and adjusted so as to ensure exposure and access to a harness 110 wearer's erotic zones. The material and composition of straps across the user's body can be dictated by each other; for example, in one instance the straps may be made of leather and thus the positioning and number of strips needs to compensate for potentially undesirable movement which could impede proper use of the erotic apparatus.

The one or more grip components 130 can be attached to harness 110 in a variety of manners. In one embodiment, grip component 130 may be a single grip handlebar that can, when attached to the harness 110, be positioned across a person's hips, buttocks, shoulders, head, and the like. In another embodiment, two separate side grips 130 can be positioned about the hips of an individual when worn. In one embodiment of the disclosure, the grip modules 130 can be de-coupled from the main harness 110 and repositioned on the harness 110 itself or interchanged for another type of grip module 130 (e.g., partner's may choose between z-bars, beach bars, ape hanger bars, and the like), which can consist of various materials and compositions of materials, for example plastic, metal, leather, rubber, etc. Some materials may be more advantageous than others due to easy cleaning and/or antibacterial or antimicrobial properties.

In this embodiment, the grips 130 can be rotated and fastened to the harness in a, from the wearer's partner's perspective, laterally forward and backward three hundred and sixty degree fashion to allow a person enjoying the erotic apparatus harness 110 to fully maximize the functions of the harness 110. For example, a person may wish to adjust the position in which the grips 130 and optional components 140 are accessible when switching between sexual positions so as to be able to comfortably reach the grips 130 and manipulate harness 110 in its intended fashion. The one or more grips 130 may also be rotated so as to allow the one or more grip 130 devices to be attached to the wearer at a slanted angle rather than a ninety degree fashion or horizontally lateral position in relation to the erotic apparatus wearer's body. This can facilitate the enjoyment of a wide range of sexual positions with the erotic apparatus. These positions may take the form of penetrating partner on top with front entry, penetrating from behind, receiving partner on top, sitting and kneeling, standing, anal positions, oral positions, positions using furniture or other devices, group sex, and the like.

To this end, as previously alluded to, the one or more grips 130 may also be detached from and consequently repositioned and reattached to the main harness 110 at another location. For example, the one or more grips 130 position on the harness during missionary position will be different from the grips 130 position during the cowgirl or doggy-style position, or even oral sex so as to allow the user to comfortably and appropriately reach the grips 130 and make full use of the erotic apparatus. In another embodiment, the rotation of parts of grip 130 components (e.g., handle-twist throttle, rheostat switches, potentiometers, and the like) can be utilized to control various stages of optional components 140 in a gear shifting fashion or to emulate the “revving” of a handlebar operated form of transport through optional vibration or sound emissions.

Optional components 140 can be a variety of handlebar mounted additions that can emulate additional components typical of a handlebar operated form of transport (e.g., horn, turn signals, throttle, levers, perches, rumbling noises/vibrations experienced when on a motorcycle, which are simulated by components integrated into the erotic apparatus, and the like). These additional optional components 140 may be fastened onto the erotic apparatus harness 110 directly instead of the grip components 130 to further enhance sexual stimulation and satisfaction. Examples of additional components 140, which may be manufactured specifically to coordinate with the claimed erotic apparatus and provide a post-sale stream of income, can be extensions such as vibrators, dildos, cock rings, nipple clamps, anal beads, handcuffs and the like. These additional components 140 can, in one embodiment of the disclosure, work in conjunction with the grip components 130. More specifically, the “revving” of the “engine” that can be simulated by, for example, twisting the grip components 130 forward and backward or operating a throttle can control various stages of vibrator speeds and intensities depending on user preference, enabling a harness 110 wearer and his or her partner maximum personalized pleasure.

In erotic apparatus embodiment 150 of harness 110, hip straps 122 and thigh straps 124 are connected via support straps 126, 128 in a fashion that can be a typical application for a female wearer. In this embodiment in accordance with the disclosure, support straps 126, 128 can be positioned in such a manner as to allow access to, for example, the female genitalia and orifices. The front support straps 126 can take the form of a single support strap 126, 128 connected to the waist strap 122 via a second support strap 126, 128 looping around waist strap 122 at a ninety degree angle approximately in the center of the waist strap 122 (i.e., positioned equidistant from the side grip handlebars 132 positioned on each the right and left side of an individual's waist).

The back support strap 128 of this particular erotic apparatus embodiment 150 of the present disclosure can be two separate support straps 126, 128 coupled to approximately the back center of the waist strap 122. In this instance, the back center support strap 158 can take the form of support straps 126, 128 that are spatially directly opposite the front center support strap 156 looping around the waist strap 122 when worn by an individual. In one embodiment, the support straps 126, 128 can be coupled to the waist 122 and thigh 124 strap either permanently (e.g., can be sewn on yet adjustable in length) or, in another embodiment, be removable and reconfigurable (e.g., through clasps, buttons, VELCRO, and the like).

Modular straps 120, and more specifically waist strap 122 as well as support straps 126, 128 provide convenient locations for attaching optional components 140. For example, in one embodiment optional pouches to hold optional extensions 140, such as vibrators, strap on dildos, cock rings, and the like, may be coupled to the harness 110. In another instance, such optional components 140 may be coupled directly to harness 110 modular straps 120 when the configuration of the optional component permits, due to the fact that optional components 140 can be traditional sex toys (legacy devices, which will be elaborated on later) in nature but may have to be redesigned in one way or another to allow for proper positioning against the wearer's body and coupling to harness 110.

In embodiment 150, the one or more grip components 130 can be a set of rigid cylindrical handlebars 132 outfitted with a throttle 142 designed to mimic motor controls of, for example, a dirtbike. Grip component 132 can be selectively attached or detached from the main harness embodiment 150 through clips, clasps, and other mechanisms of the sort. Throttle 142 can include other sex toy components such as battery powered vibrators controlled through manipulation of the throttle. More extensive and complicated configurations of handlebars 132 and throttle 142 may consist of a single grip component 130 that incorporates both a handlebar 132 and thrust controller 142 such as twist-grip levers where grip 130 components can be rotated forward or backward from the user's perspective in a at least ninety degree fashion to manipulate vibrations, sound, and other sensations emitted by the erotic apparatus embodiment harness 150 and optional components 140, in this embodiment 132, 142.

Embodiment 160 of the claimed erotic apparatus shows a modular strap 120 configuration consisting of shoulder and chest or hip straps that can attach a single Z-bar handlebar grip component 130 to a wearer's chest. This configuration can be especially ideal for a cowgirl or missionary position. In contrast, in embodiment 170, modular straps 120 are configured to a body harness with shoulder, back, and thigh straps. In this particular embodiment the single handlebar grip component 130 can be attached to a wearer's back allowing for full intended use of the claimed erotic apparatus during, for example, back to stomach positions such as doggy style, anal, and the like, or even sitting and kneeling sexual positions that often demand a partner to reach around his or her partner's torso.

In accordance with another embodiment of the disclosure, the harness for the erotic apparatus can be fashioned in such a manner as to resemble a sex swing to allow individuals to experience the combination of the sensation of riding, for example, a motorcycle coupled with a wider range of sexual positions uninhibitedly, including oral, anal, and the like. In other words, the conventional sex swing strap configuration can be considered a harness 110 to which one or more grip devices 130 may be coupled. For instance, in one embodiment, grip devices 130 may be coupled to either side of the bar, which the sex swing is suspended from, as is represented by embodiment 180. In another example, the bar may not be present and the sex swing may be anchored to a wall or suitable frame directly; in this embodiment, one or more grip 130 devices may be coupled to another portion of the sex swing strap composition as shown by embodiment 190. Other harness 110 modular strap 120 configurations and grip components 130 are enabled and the disclosure is not limited to erotic apparatus embodiment 150, 160, 170, 180, and 190 of harness 110.

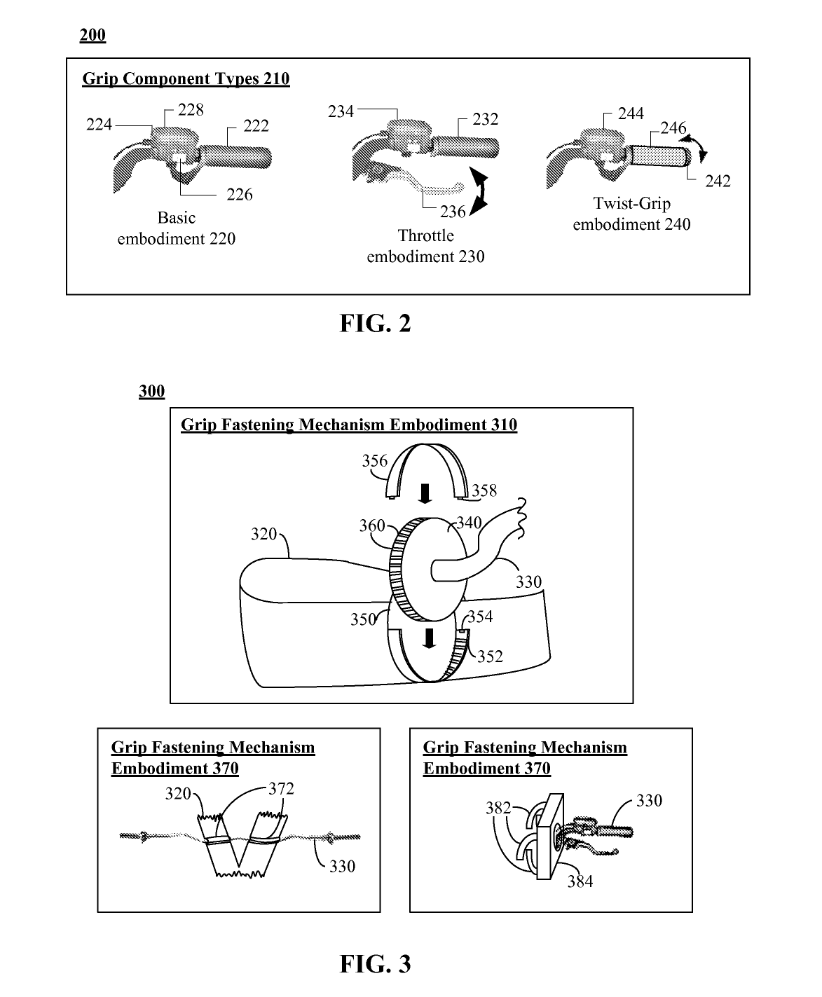

FIG. 2 is a depiction that shows additional details specific to the grip component types 210 in accordance with an embodiment of the disclosure. These grips 210 can be interchangeably attached to the harness erotic apparatus. Grip component types 210, such as basic grip embodiment 262, can consist of a cylindrically shaped body 222 that when coupled to the harness can result in a grip 222 protruding horizontally from the wearer's body at an angle of ninety degrees. Other angles than ninety degrees are contemplated and can be utilized in various embodiments. The cylindrical shaped body can be attached to the harness 110 on one of its two ends, while the other end can remain unattached to the harness 110. In another embodiment, the grip component 210 can be fastened to the harness across a wearer's shoulders, chest, head, or buttocks in a lateral fashion (tangential to a wearer's body) in that a single handlebar grip 210 may be attached to and repositioned on the erotic apparatus in a number of places.

The grip 222 can take on a variety of designs, such as straight protruding rods, z-bars (any sharply angled handlebar with either long or short straight rise sections, which are sharply angled upward from the mounting points and again sharply angled to the handgrip and control area), beach bars (any bars that slope back towards the “rider” for a more relaxed pose), and the like. Each of these grip 222 options can have advantages coupled with the harness 110 when rotated threehundredsixty degrees and fastened for proper positioning in differing sexual positions and can be selected and interchangeable for erotic apparatus embodiment 150 based upon personal preference. A suitable material for the cylindrical grip can be, for example, machine molded PVC, metal, rubber, and the like.

Grip component types 210 can be further enhanced via the optional components 224, 226, 228, 234, 236, 244, 246. In one embodiment, an optional theme box 224 for basic embodiment 220 can be a battery powered sound emitting device with a simple on and off switch 226 that can include speakers 228 to play user desired noises, such as noises emulating engine revving and the like. It should be noted, that in another embodiment wireless speakers can be integrated or remote; for example, sound can be produced by an external stereo system that receives wireless commands from the harness 110 components.

Further optional components 210 are shown in both the throttle embodiment 230 and twist-grip embodiment 240. Throttle embodiment 230 can expand upon the basic embodiment 210 by adding a throttle 236 as an optional component 140. Throttle 236 can function in purpose much like a traditional motorcycle or ATV throttle in that it can be utilized to operate stages of optional components 234. In one embodiment, optional component 234 can contain hardware similar to optional theme box 224, but can further be enhanced with items such as vibrators that can be have different stages of intensity engaged through user manipulation of the throttle 236. User manipulation of a throttle 236 usually occurs by pressing the lever forward away from the user's body and pulling it backward towards the user's body in a horizontal manner or can be done by pulling vertically upward or pushing vertically downward on the lever.

In embodiment 240 (twist-grip embodiment), manipulation of stages of theme box 244 that can be similar to theme boxes 224 and 234 can be performed by rotating grip sheath 246 across rod 242 forward and backward (i.e., away and towards the “rider's” body) at least ninety degrees before encountering resistance that can trigger, for example, a “gear change” which can be manifested through changing intensity or noise of “engine rumblings.” These optional controls add sexual excitement by allowing the user (i.e., “rider”) of harness 110 to experience both sound and sensation additionally to experiencing the control over a handlebar manipulated form of transport.

Optional components 140 may also be legacy devices. People often reach for already existing sex toys to achieve a thrill in spicing up their sex life, increasing pleasure from sexual stimulation and fostering intimacy among partners. To this end, many individuals have a preferred legacy device that meets their specific needs. As an alternative to specialized retrofit optional components 140 for the claimed erotic apparatus, combining the individual's preferred legacy devices with the claimed erotic apparatus is thus a crucial contemplation. These legacy devices, for example, vibrators, dildos, cock rings, and the like, often have multiple stages of operation aside from the simple on and off state and are often controlled through push buttons, dials, simple switches, or even digitally. In order to be incorporated into the claimed erotic apparatus in a manner where the one or more grip component types 210 control the stages of the legacy devices, a legacy adapter can be fashioned, embodiments of which will be discussed in detail later.

Other grip component devices and types 210 are enabled and the disclosure is not limited to grip component types 210, i.e. basic embodiment 220, throttle embodiment 230, twist-grip embodiment 240, and their corresponding optional components 224, 226, 228, 234, 236, 244, 246 and optional component configurations.

FIG. 3 is a set of depictions of potential examples for a coupling device that can be used to fasten the one or more grip components to the harness in accordance with an embodiment of the disclosure. Grips 130 and optional controls 140 can be attached to the harness 110 and its modular straps 120 in a variety of ways. In one embodiment they can be coupled to the harness 110 straps 120 permanently through sewing, molding, gluing, etc. In another embodiment, they can be detachable and be affixed to the harness 110 via clasps, clips, straps, VELCRO, buttons, and the like. Grip fastening mechanism embodiment 310 can include hip strap 320, grip 330 which can be permanently mounted onto grip plate 340 and grip plate halter 350. Grip plate halter 350 can include a bottom grip plate receptacle 352, which can include clasp receiver 354, and a top grip plate receptacle 356, which can include clasp 358. In one embodiment, grip plate 340 can include rails 360 on its lateral sides that can allow grip plate 340 to turn and fasten to the grip plate halter 350 and its receptacles 352, which in turn can contain the same rails 360, resulting in a threehundredsixty degree fashion forward and backward motion.

In this fashion, in one embodiment of the erotic apparatus grip components 130 can be interchanged for various shapes, sizes and material compositions depending on user preference and potentially attached optional components 140. Materials suitable for grip plate 340, grip plate halter 350, bottom grip plate receptacle 352, clasp receiver 354, top grip plate receptacle 356, clasp 358, can include but are not limited to metal, machine moldable PVC, other types of plastics, rubber and the like. As outlined previously, in another embodiment in accordance with the disclosure, grip component 130 can be permanently attached to harness 110 through molding, sewing and the like.

In another grip fastening mechanism embodiment 370, the one or more grip components may be attached to the erotic apparatus harness 110 via loops 372 that can be permanently affixed to the modular straps 320 in various locations and that may be fastened or closed around attached one or more grip devices 330 through VELCRO, buttons, push closures, and the like. In yet another embodiment 380, one or more grip components 330 can be either permanently affixed to or selectively attached to a fastening pad 384, which in turn can be attached to any position of a strap 320 configuration, via loops 382. Fastenings other than loops 382, such as pull closures, claps, buttons, and the like are also contemplated. Other grip fastening mechanisms are enabled and the disclosure is not limited to grip fastening mechanism embodiment 310, 370, 380 and its components and configuration.

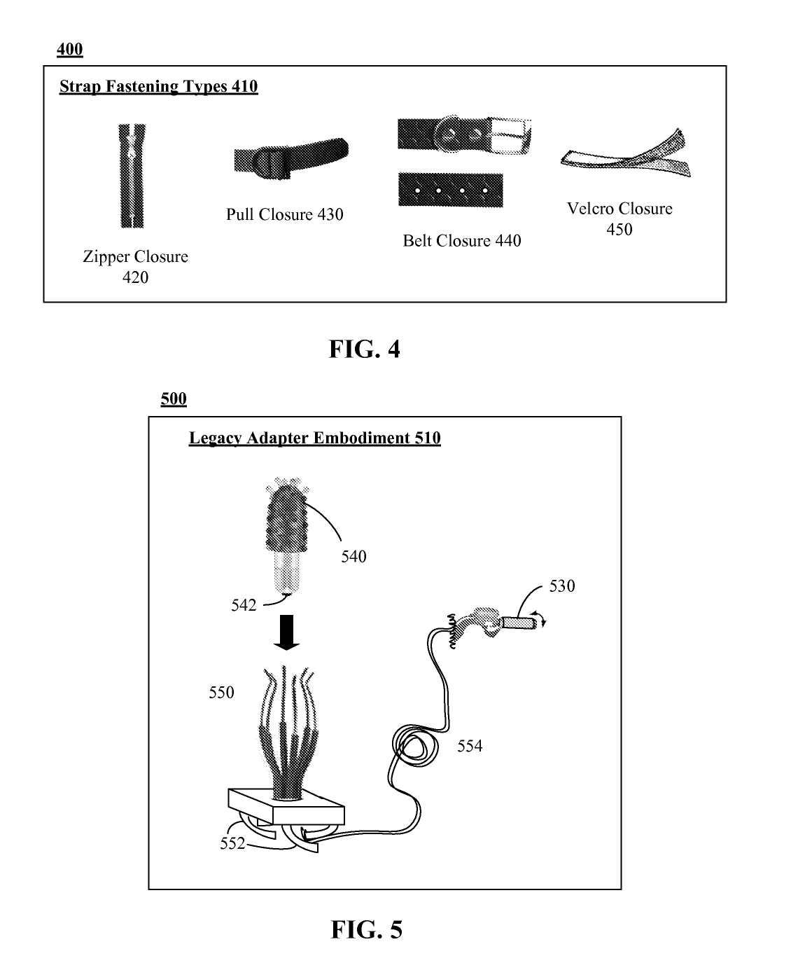

FIG. 4 is a depiction 400 of examples for strap tightening and fastening mechanisms 420, 430, 440, 450 in accordance with an embodiment of the disclosure. Various strap fastening types 140 are contemplated and the ones depicted and described in the disclosure are by no means intended to be limiting. Other fastening types that function in the intended use for fastening and holding in place the harness 110 components, such as modular straps 120, grip components 130, and optional components 140 against a user's body in the intended fashion are contemplated.

In one embodiment modular straps 120 can be coupled to one another and grip components 130 can be fastened to harness 110 via conventional zipper closure 420. The zipper closure limitations reside in the fact that they are not as readily modified for various user's body types but fasten components to one another in a secure manner. In another embodiment a pull closure 430 may be utilized to gradually tighten straps 120 against a user's body. The advantages of the pull closure can be that they are very readily adjustable to various user's body types and can quickly be adjusted during use of the device if necessary. One disadvantage is, however, that its use and proper function is highly dependent upon the type of material used for the strap as the strap pull closure can loosen somewhat in some instances.

Belt closure 440 can be utilized to provide more readily available harness adaptation to a user's body and at the same time provide tight control and coupling of straps or components to one another in accordance with one embodiment of the disclosure. A VELCRO closure 450 can also be implemented, and for optimal fastening purposes may be double layered with two VELCRO closures 450 being utilized wherein one layer of VELCRO 450 attaches components to one another followed by a second layer of VELCRO 450 in a ninety degree fashion on top of the bottom layer. This dual layering can ensure that the VELCRO closure 450 does not accidentally open during device use due to forceful movement. Some of the fastening types 410 function better than others for various purposes and more than one fastening type can be utilized in a single harness 110 as is necessary or desired for the erotic apparatus to perform its intended use to the user's satisfaction. Other strap adjustment and fastening types are enabled and the disclosure is not limited to strap adjustment and fastening types 410 and closures 420, 430, 440, and 450.

FIG. 5 is a depiction 500 of an example of a legacy adapter 510 that allows legacy sex toy devices to be functionally incorporated into the claimed erotic apparatus in accordance with an embodiment of the disclosure. The successful incorporation of legacy devices 540 as optional components 140 of the claimed erotic apparatus is dependent upon identifying the conventional device's 540 control mechanism and utilizing a proper mechanism for adjusting the previously mentioned stages of operation of legacy sex toys 540. Some examples of legacy devices 540 to be functionally coupled to the claimed erotic apparatus can be vibrators, dildos, cock rings, misters for added lubrication, and the like.

These devices' 540 stages (i.e., on, off, variable speed/intensity) can be controlled through push buttons, dials, simple switches, or even digitally or remotely. In order to be incorporated into the claimed erotic apparatus in a manner where the grip components 120 control the stages of the legacy devices, a legacy adapter can be fashioned. Legacy adapters will change depending on the specific need. For example, in one embodiment, for digitally controlled devices, a digital interface is needed to control the legacy devices' stages via optional components (e.g., twist-throttle, rheostat switches, potentiometers, etc.) of the grip device.

In another embodiment, for legacy devices 540 controlled via push buttons 542, the legacy adapter 510 can include a locking clamp 550 which holds the legacy device in place. The locking clamp may be fastened to the erotic apparatus via loops 552 which can be made of VELCRO or close with buttons, snaps, clasps, and the like. In this embodiment, the locking clamp 550 can include caps that are hooked to electronics in the grip component 530 via cable 554 that have actuators to control mechanical movement of the locking clamp 550 which in turn will actuate the push button 542 on the legacy device 540 when activated. In another embodiment, instead of the locking clamp 550, a locking slot may be utilized along with a secondary ring or rubber component, the locking ring, that can further function to lock the legacy device firmly in place. This can serve to ensure that the device and potential grip components 120 work in conjunction to control the legacy device's stages of operation. Other types of legacy adapters are enabled and the disclosure is not limited to legacy adapter embodiment 510 and its components and configurations.

In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the invention. In addition, while a particular feature of the invention can have been disclosed with respect to only one of several implementations, such feature can be combined with one or more other features of the other implementations as can be desired and advantageous for any given or particular application. Furthermore, to the extent that the terms “including”, “includes”, “having”, “has”, “with”, or variants thereof are used in either the detailed description and/or the claims, such terms are intended to be inclusive in a manner similar to the term “comprising”.

What is claimed is:

1. An erotic apparatus comprising:
a harness configured to be worn by a human, referred to as a wearer, during erotic activity with another human, referred to as a sexual partner, where erotic zones of the wearer are exposed to the sexual partner when worn; and
a handlebar, said handlebar extruding from the body of the wearer when worn, so that the sexual partner of the wearer is able to grip the handlebar when engaging in an erotic activity, where the erotic apparatus of claim 1, wherein said handlebar resembles at least one of a bicycle, motorcycle, ATV, snowmobile, scooter, JET SKI or water ski handlebar.

2. The erotic apparatus of claim 1, wherein said harness is configured in the shape of at least one of a shoulder harness, a head harness, a body harness, a chest support harness, and a climbing harness.

3. The erotic apparatus of claim 1, wherein said handlebar includes at least one of motorized transport controls configured to resemble a turn signal, break, horn, gear shift, throttle lever, or rheostat switch.

4. The erotic apparatus of claim 3, wherein said motorized transport controls each comprise a switch able to be toggled in state by hands of the sexual partner when the handlebar is gripped by the sexual partner, wherein a change of state resulting from a switch produces a responsive output experienced by at least one of the wearer and the sexual partner.

5. The erotic apparatus of claim 3, wherein said at least one of motorized transport controls produces sound or vibrations when actuated by the sexual partner, thus adding to the sexual partner's sensation of operating a handlebar manipulated form of transport when engaged in the erotic activity.

6. The erotic apparatus of claim 3, wherein said at least one of motorized transport controls manipulates the intensity of noise or vibrations emitted via another one of said motorized transport controls.

7. The erotic apparatus of claim 1, wherein at least one erotic component is coupled to said erotic apparatus, said at least one optional component, when actuated, stimulating one or more of the wearer's erotic zones.

8. The erotic apparatus of claim 1, wherein said one or more erotic components is functionally coupled to said handlebar.

9. The erotic apparatus of claim 1, wherein said erotic apparatus is configured to include indicia for a characteristic of a particular brand of motorized transport.

10. The erotic apparatus of claim 1, wherein said one or more erotic components are configured to be a legacy device functionally coupled to the erotic apparatus and its components, wherein when functionally coupled, change to controls of the handlebar change an operational state of said legacy device.

11. An erotic apparatus comprising:
a harness for erotic activity between humans, referred to as a sexual partners, where erotic zones of the sexual partners are exposed;
a handlebar, said handlebar extruding from the surface when attached so that the sexual partners can grip the handlebar when engaging in an erotic activity, and said handlebar including at least one of motorized transport controls configured to resemble at least one of a turn signal, break, horn, gear shift, throttle lever, and rheostat switch, each of said motorized transport controls including at least one switch; and
at least one erotic component, each erotic component having at least two states of operation, controlled by the switch, wherein at least one state of operation for each erotic component stimulates an erotic zone of at least one of the sexual partners.

12. The erotic apparatus of claim 11, wherein said harness is coupled to a free standing apparatus.

13. The erotic apparatus of claim 12, wherein said free standing apparatus is at least one of a sex swing, a weight bearing frame, a bed, a chair, a sofa, a table, a counter, a pole, and a railing.

14. The erotic apparatus of claim 11, wherein said harness is designed to be worn on the body of one of the sexual partners.

15. The erotic apparatus of claim 11, wherein said handlebar resembles handlebars of a motorcycle.

16. The erotic apparatus of claim 11, wherein said at least one of motorized transport controls produces sound or vibrations in a fashion adding to the sexual partners' sensation of operating a handlebar manipulated form of transport when engaged in the erotic activity.

17. The erotic apparatus of claim 11, wherein said erotic apparatus is configured to include branding of a specific motorcycle manufacturer.

18. The erotic apparatus of claim 11, wherein motorized transport controls configurations correspond to a specific manufacturer of motorcycles or a specific motorcycle model.

19. The erotic apparatus of claim 1, wherein said one or more erotic components are configured to be a legacy device functionally coupled to the erotic apparatus and its components, wherein when functionally coupled, change to controls of the handlebar change an operational state of said legacy device.

20. An erotic apparatus embodiment comprising:
a harness configured to be worn by a human, referred to as the wearer, during erotic activity with another human, referred to as a sexual partner, where erotic zones of the wearer are exposed to the sexual partner when worn;
a handlebar of a motorcycle, said handlebar extruding from the body of the wearer when worn, so that the sexual partner of the wearer is able to grip the handlebar when engaging in an erotic activity; and
controls on the handlebar, said controls when manipulated by a sexual partner produce at least one of sound, vibrations, feedback to stimulation of erotic zones of the wearer.
